(19) United States
(12) Patent Application Publication
(10) Pub. No.: US 2018/0155963 A1
(43) Pub. Date: Jun. 7, 2018

(54) Built-in lift sliding door lock

(71) Applicant: ASSA ABLOY Guoqiang (Shandong) Hardware Technology Co., Ltd., Leling (CN)

(72) Inventors: Junlan Cao, Leling (CN); Xiaobo Jin, Leling (CN); Mingzhe Xu, Leling (CN)

(73) Assignee: ASSA ABLOY Guoqiang (Shandong) Hardware Technology Co., Ltd.

(21) Appl. No.: 15/885,839

(22) Filed: Feb. 1, 2018

(30) Foreign Application Priority Data
Oct. 13, 2017 (CN) 201709511720.X

(51) Int. Cl. E05B 65/08; E05C 1/00

(52) U.S. Cl. CPC E05B 65/08; E05C 1/00

(57) ABSTRACT

The present invention relates to a technical field of building doors and windows drivers, and more particularly to a built-in lift sliding door lock, which includes a lock point linkage mechanism and a lock seat, wherein the lock seat is a flat structure adapted for being embedded into an extrudate, and has an import slot and a locking slot communicated with the import slot; the lock point linkage mechanism includes a lock point, a sliding plate, a fixed plate, a first plectrum, a second plectrum, a connecting piece and a cam. Beneficial effects of the present invention are as follows. Displacement changes of the lock point are converted into rotation changes of the cam for damping conversion, which is flexible and convenient, and enhances feel comfort. The present invention has ingenious structure, moderate structural complexity, low failure rate through the component connection method and long service life.

### CROSS REFERENCE OF RELATED APPLICATION

The present invention claims priority under 35 U.S.C. 119(a-d) to CN 201710951720.X, filed Oct. 13, 2017.

### BACKGROUND OF THE PRESENT INVENTION

### Field of Invention

The present invention relates to a technical field of building doors and windows drivers, and more particularly to a built-in lift sliding door lock.

### Description of Related Arts

The lock points of current sliding door locks applied to the buildings are abruptly fixed on the door frame; while going in or out of the door, it is easy for children to bump collide and cause injury, and adults often have clothes hooked up. In addition, the traditional lift door locks, either have simple structure, which adopt the lock handle to directly lift the lock point and stiffly combine internal structures; or have complex structure, which are prone to failure in components and greatly reduce the use experience and the life expectancy.

### SUMMARY OF THE PRESENT INVENTION

To solve problems mentioned above and make up for deficiencies of the traditional technology, the present invention provides a built-in lift sliding door lock, which is able to avoid bumping, and has ingenious structure and long service life.

The present invention is achieved through technical solutions as follows.

A built-in lift sliding door lock comprises a lock point linkage mechanism and a lock seat, wherein the lock seat is a flat structure adapted for being embedded into an extrudate, and has an import slot and a locking slot communicated with the import slot; the lock point linkage mechanism comprises a lock point, a sliding plate, a fixed plate, a first plectrum, a second plectrum, a connecting piece and a cam, wherein the lock point is fixed to the sliding plate, the sliding plate has multiple poking holes for respectively engaging with a first poking head and a second poking head; the first plectrum is riveted with the second plectrum through first rivets; a buckling body formed by the first plectrum and the second plectrum is movably connected with one end of the connecting piece through a hinge shaft; the other end of the connecting piece is hinged to the cam through second rivets; the cam is movably installed to a main plate and installed with a reset spring; the main plate is vertically fixed to the fixed plate and then is buckled with a vice plate for protecting and sealing.

Preferably, the lock point has a protruding column structure, an outer rim surface of the column structure has a groove, a width of the import slot of the lock seat is larger than a maximum diameter of the column structure of the lock point, a width of the locking slot is larger than an inner diameter of the groove of the column structure of the lock point and is smaller than the maximum diameter of the column structure of the lock point.

Preferably, the first plectrum comprises a first L-shaped portion and a first protrusion, the second plectrum comprises a second L-shaped portion and a second protrusion; when the first plectrum is symmetrically buckled with the second plectrum, the first L-shaped portion is engaged with the second L-shaped portion to form the first poking head, the first protrusion is engaged with the second protrusion to form the second poking head.

Preferably, the first plectrum is riveted with the second plectrum through two first rivets.

Preferably, the hinge shaft is a stepped cylindrical shaft.

Preferably, a double-clamping piece is fixed on the cam for installing the connecting piece.

Beneficial effects of the present invention are as follows. Displacement changes of the lock point are converted into rotation changes of the cam for damping conversion, which is flexible and convenient, and enhances feel comfort. The present invention has ingenious structure, moderate structural complexity, low failure rate through the component connection method and long service life. Moreover, the built-in structure of the lock point facilitates being installed inside the door leaf, and the flat structure of the lock seat facilitates being embedded into the door frame, so as to avoid knocking when children go in or out of the door or avoid hooking clothes when adults go in or out of the door. Furthermore, the built-in lift sliding door lock provided by the present invention is nice in appearance and safe to be used.

### BRIEF DESCRIPTION OF THE DRAWINGS

The present invention is further explained with accompanying drawings.

FIG. 1 is a structurally schematic view of a built-in lift sliding door lock according to a preferred embodiment of the present invention.

FIG. 2 is a structurally schematic view of a lock point linkage mechanism of the built-in lift sliding door lock in FIG. 1.

FIG. 3 is an effect diagram of the door lock at an open state when a sliding door is opened.

FIG. 4 is an effect diagram of the door lock at a closed state when the sliding door is closed.

FIG. 5 is a structurally schematic view of a lock point of the lock point linkage mechanism in FIG. 2.

FIG. 6 is a structurally schematic view of a sliding plate of the lock point linkage mechanism in FIG. 2.

FIG. 7 is a structurally schematic view of a first plectrum of the lock point linkage mechanism in FIG. 2.

FIG. 8 is a structurally schematic view of a second plectrum of the lock point linkage mechanism in FIG. 2.

FIG. 9 is a structurally schematic view of a first rivet of the lock point linkage mechanism in FIG. 2.

FIG. 10 is a structurally schematic view of a hinge shaft of the lock point linkage mechanism in FIG. 2.

FIG. 11 is a structurally schematic view of a connecting piece of the lock point linkage mechanism in FIG. 2.

FIG. 12 is a structurally schematic view of a cam of the lock point linkage mechanism in FIG. 2.

FIG. 13 is a structurally schematic view of a second rivet of the lock point linkage mechanism in FIG. 2.

FIG. 14 shows the first plectrum is buckled with the second plectrum.

In the drawings, 1: lock seat; 2: locking slot; 3: import slot; 4: lock point; 401: groove; 5: lock point linkage mechanism; 6: cam; 7: main plate; 8: hinge shaft; 9: sliding plate; 10: first plectrum; 101: first L-shaped portion; 102: first protrusion; 11: second plectrum; 111: second L-shaped portion; 112: second protrusion; 12: first rivet; 13: connecting piece; 14: fixed plate; 15: second rivet; 16: sliding door; 17: poking hole; 18: lock point fixing hole; 191: first poking head; 192: second poking head; 20: double-clamping piece; 21: reset spring; 22: vice plate.

### DETAILED DESCRIPTION OF THE PREFERRED EMBODIMENT

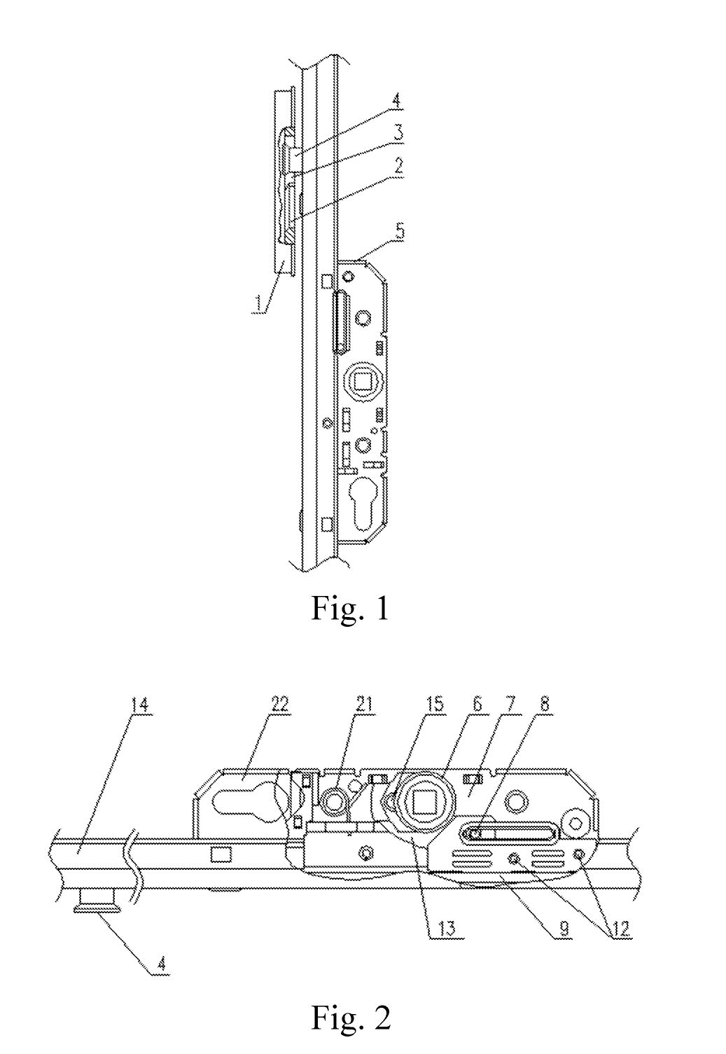

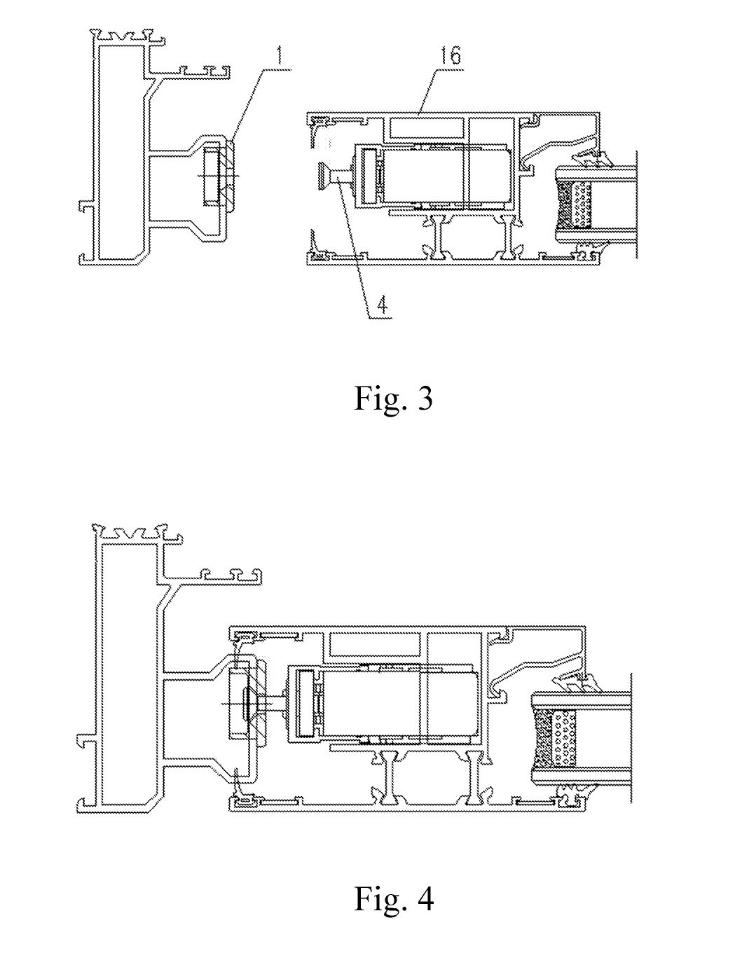

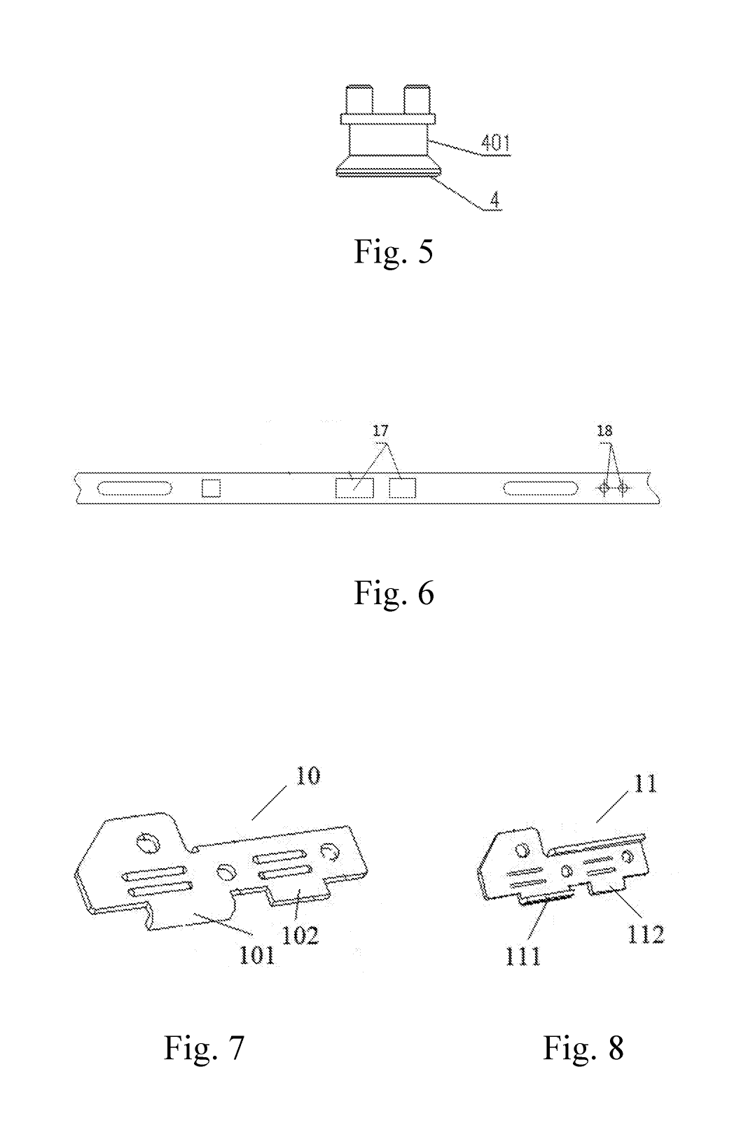

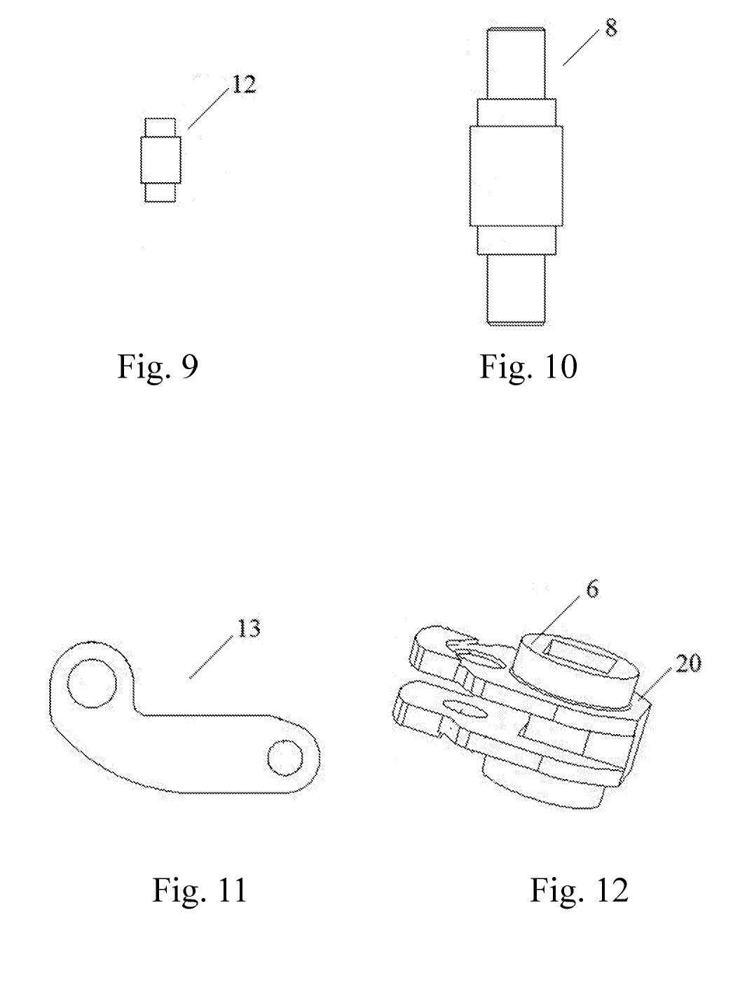

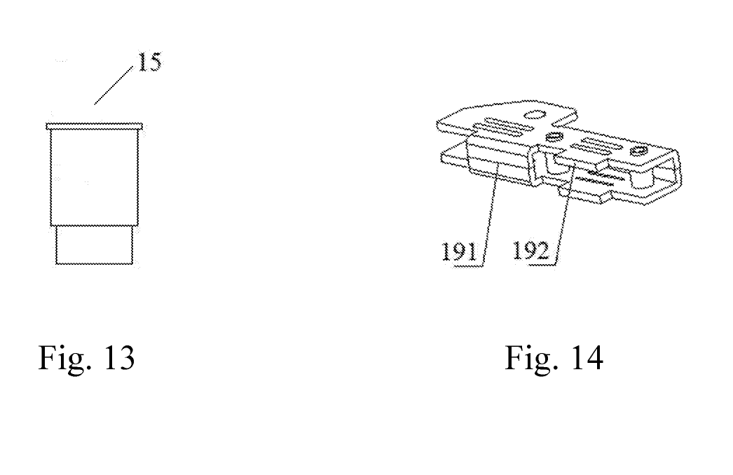

As shown in FIGS. 1 to 14, a built-in lift sliding door lock according to a preferred embodiment of the present invention is illustrated, which comprises a lock point linkage mechanism 5 and a lock seat 1, wherein the lock seat 1 is a flat structure adapted for being embedded into an extrudate, and has an import slot 3 and a locking slot 2 communicated with the import slot 3; the lock point linkage mechanism 5 comprises a lock point 4, a sliding plate 9, a fixed plate 14, a first plectrum 10, a second plectrum 11, a connecting piece 13 and a cam 6, wherein the lock point 4 is fixed to the sliding plate 9, the sliding plate 9 has multiple poking holes 17 for respectively engaging with a first poking head 191 and a second poking head 192; the first plectrum 10 comprises a first L-shaped portion 101 and a first protrusion 102, the second plectrum 11 comprises a second L-shaped portion 111 and a second protrusion 112; when the first plectrum 10 is symmetrically buckled with the second plectrum 11, the first L-shaped portion 101 is engaged with the second L-shaped portion 111 to form the first poking head 191, the first protrusion 102 is engaged with the second protrusion 112 to form the second poking head 192; the first plectrum 10 is riveted with the second plectrum 11 through first rivets 12; a buckling body formed by the first plectrum 10 and the second plectrum 11 buckled with the first plectrum 10 is movably connected with one end of the connecting piece 13 through a hinge shaft 8; the other end of the connecting piece 13 is hinged to the cam 6 through second rivets 15; the cam 6 is movably installed to a main plate 7 and installed with a reset spring 21; the main plate 7 is vertically fixed to the fixed plate 14 and then is buckled with a vice plate 22 for protecting and sealing. The lock point 4 has a protruding column structure, an outer rim surface of the column structure has a groove 401, a width of the import slot 3 of the lock seat 1 is larger than a maximum diameter of the column structure of the lock point 4, a width of the locking slot 2 is larger than an inner diameter of the groove 401 of the column structure of the lock point 4 and is smaller than the maximum diameter of the column structure of the lock point 4. The first plectrum 10 is riveted with the second plectrum 11 through two first rivets 12. The hinge shaft 8 is a stepped cylindrical shaft. A double-clamping piece 20 is fixed on the cam 6 for installing the connecting piece 13.

When the built-in lift sliding door lock provided by the present invention is used, the cam 6 drives the connecting piece 13 to rotate, so as to pull the buckling body formed by the first plectrum 10 and the second plectrum 11; and then the buckling body drives the sliding plate to move, so that the lock point 4 is able to switch back and forth within the import slot 3 and the locking slot 2 of the lock seat 1, thereby achieving an open and lock effect.

The basic principles and main features of the present invention have been shown and described above. It should be understood by those skilled in the art that the present invention is not limited to the above embodiments, and the above embodiments and description only illustrate the principle of the present invention. Various changes and modifications, which may be made without departing from the spirit and scope of the present invention, all fall within the protection scope of the present invention.

What is claimed is:

1. A built-in lift sliding door lock, comprising a lock point linkage mechanism and a lock seat, wherein the lock seat is a flat structure adapted for being embedded into an extrudate, and has an import slot and a locking slot communicated with the import slot; the lock point linkage mechanism comprises a lock point, a sliding plate, a fixed plate, a first plectrum, a second plectrum, a connecting piece and a cam, wherein the lock point is fixed to the sliding plate, the sliding plate has multiple poking holes for respectively engaging with a first poking head and a second poking head; the first plectrum is riveted with the second plectrum through first rivets; a buckling body formed by the first plectrum and the second plectrum buckled with the first plectrum is movably connected with one end of the connecting piece through a hinge shaft; the other end of the connecting piece is hinged to the cam through second rivets; the cam is movably installed to a main plate and installed with a reset spring; the main plate is vertically fixed to the fixed plate and then is buckled with a vice plate for protecting and sealing.

2. The built-in lift sliding door lock, as recited in claim 1, wherein the lock point has a protruding column structure, an outer rim surface of the column structure has a groove, a width of the import slot of the lock seat is larger than a maximum diameter of the column structure of the lock point, a width of the locking slot is larger than an inner diameter of the groove of the column structure of the lock point and is smaller than the maximum diameter of the column structure of the lock point.

3. The built-in lift sliding door lock, as recited in claim 1, wherein the first plectrum comprises a first L-shaped portion and a first protrusion, the second plectrum comprises a second L-shaped portion and a second protrusion; when the first plectrum is symmetrically buckled with the second plectrum, the first L-shaped portion is engaged with the second L-shaped portion to form the first poking head, the first protrusion is engaged with the second protrusion to form the second poking head.

4. The built-in lift sliding door lock, as recited in claim 1, wherein the first plectrum is riveted with the second plectrum through two first rivets.

5. The built-in lift sliding door lock, as recited in claim 1, wherein the hinge shaft is a stepped cylindrical shaft.

6. The built-in lift sliding door lock, as recited in claim 1, wherein a double-clamping piece is fixed on the cam for installing the connecting piece.
